(19) United States
(12) Patent Application Publication
(10) Pub. No.: US 2009/0264113 A1
(43) Pub. Date: Oct. 22, 2009

(54) MOBILE PHONE THAT AUTOMATICALLY MAKES CONFERENCE CALLS AND METHOD FOR SAME

(75) Inventor: Yu-Syuan Jheng, Yilan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/107,153

(22) Filed: Apr. 22, 2008

(51) Int. Cl. H04M 3/42

(52) U.S. Cl. 455/416

(57) ABSTRACT

The invention provides a method to increase accessibility for automatically making conference calls. First, a group list referring to a plurality of remote phones selected by a user is received with a local mobile phone. The local mobile phone then automatically performs an automatic conference-call procedure by handling all protocols to establish a conference call between the local mobile phone and the remote phones according to the group list without user intervention.

### BACKGROUND OF THE INVENTION

1. Field of the Invention

The invention relates to mobile phones, and more particularly to establishing conference calls between mobile phones.

2. Description of the Related Art

When a user with a mobile phone wants to communicate with multiple remote parties, the user can sequentially make a lot of calls to the remote parties or make only a conference call to the remote parties. A conference call is a mobile phone function enabling a user to simultaneously communicate with multiple remote parties. For establishing a conference call, it is required to issue a lot of cumbersome commands to the network. The conference call, however, is difficult to be established by mobile user because of poor call management for integrating the variety of commands. It is therefore mobile phones and methods for same are required to increase accessibility for making a conference call.

### BRIEF SUMMARY OF THE INVENTION

The invention provides a method for automatically making conference calls by handling all protocols. First, a group list referring to a plurality of remote phones selected by a user is received with a local mobile phone. The local mobile phone then performs an automatic conference-call procedure according to the group list to establish a conference call between the local mobile phone and the remote phones.

The invention also provides a communication terminal which supports the functionality for establishing conference call automatically. In one embodiment, the mobile phone comprises a radio frequency (RF) module, an input device, and a baseband unit. The baseband processor receives a group list referring to a plurality of remote phones selected by a user via the input device, and performs an automatic conference-call procedure according to the group list to establish a conference call between the mobile phone and the remote phones via the RF module.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of an embodiment of man-machine interface (MMI) manipulations operated by a user to initiate a conference call;

FIG. 2 is a schematic diagram of a network for coupling to multiple mobile phones;

FIG. 3 is a schematic diagram of an embodiment of a method of MMI manipulations operated by a user to automatically make a conference call according to the invention;

FIG. 4 is a block diagram of an embodiment of a mobile phone for automatically making conference calls according to the invention;

FIG. 5 is a flowchart illustrating an embodiment of a method for automatically making conference calls according to then invention;

FIG. 6 shows a sequence diagram illustrating a first situation of protocol message exchange between four mobile phones to automatically establish a conference call according to the invention;

FIG. 7 shows a sequence diagram illustrating a second situation of protocol message exchange between four mobile phones to automatically establish a conference call according to the invention; and

FIG. 8 shows a sequence diagram illustrating a third situation of protocol message exchange between four mobile phones to automatically establish a conference call according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

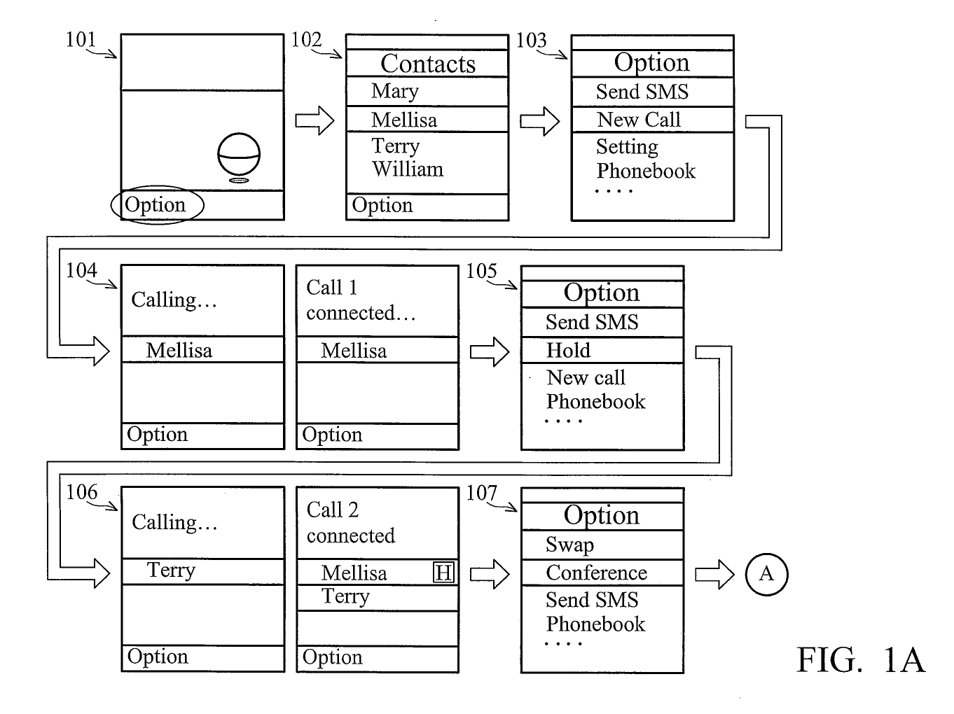

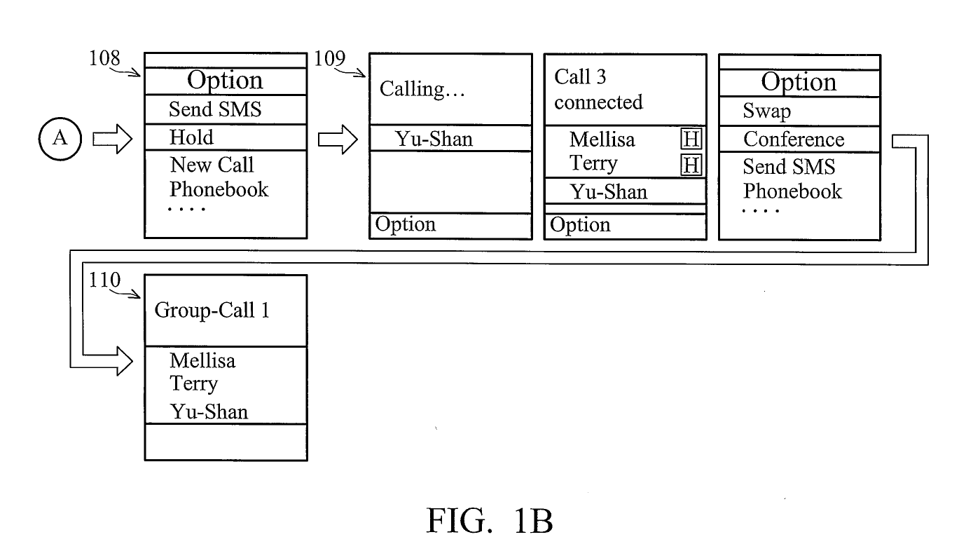

Referring to FIG. 1, a schematic diagram of an embodiment of MMI manipulations operated by a user to initiate a conference call is shown. Assume that the user wants to make a conference call to communicate with three remote parties including Mellisa, Terry, and Yu-Shan. The user first operates a mobile phone to make a call to Mellisa at step 101˜103. After the call to Mellisa is connected at step 104, the user must operate the mobile phone to hold the call to Mellisa at step 105. The user then operates the mobile phone to make a call to Terry at step 106. After the call to Terry is connected, the user selects a conference option of the mobile phone at step 107 to combine the held call to Mellisa with the call to Terry to obtain a conference call.

The user cannot stop to communicate with Mellisa and Terry because there is still a remote party, Yu-shan, which has yet to be called. The user then operates the mobile phone to hold the conference call at step 108 and then operates the mobile phone to make a call to Yu-shan at step 109. After the call to Yu-Shan is connected, the user selects the conference option of the mobile phone again at step 109 to combine the held conference call with the call to Yu-Shan to obtain a final conference call. The conference call with three remote called parties is made at step 110, and the user can simultaneously communicate with Mellisa, Terry, and Yu-Shan via the conference call. The user, however, must operate the mobile phone through a series of cumbersome man-machine interface (MMI) manipulations at step 101˜110 to make the conference call. With an increasing number of the called parties participating in a conference call, the conference call is even more cumbersome to be established. Thus, for automatically establishing a conference call without user intervention, the invention provides an embodiment of a call management method for integrating a variety of commands to the network.

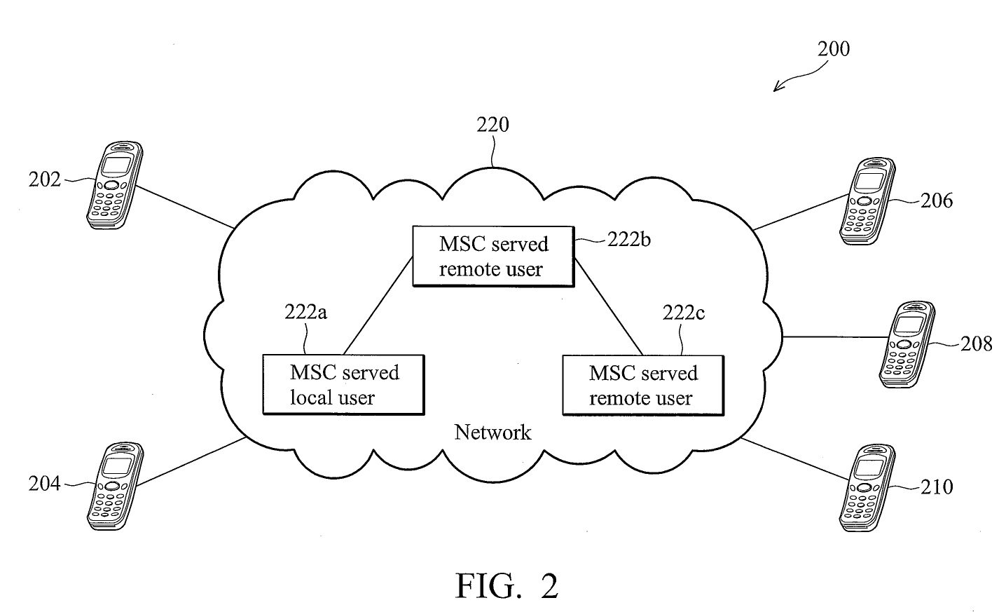

Referring to FIG. 2, a schematic diagram of a network for coupling to multiple mobile phones is shown. A local mobile phone 202 may establish a conference call to simultaneously communicate with multiple remote mobile phones 204˜210 via a network 220. The network 220 comprises one or more mobile switching center (MSC) 222a, 222b, and 222c. The MSC is a sophisticated telephone exchange which mainly provides circuit-switched calling, mobility management, and communication services to the mobile phones roaming within the area that it serves. When a user wants to communicate with remote users via the mobile phones 204˜206, the local mobile phone 202 must send messages to the MSC 222a, 222b, and 222c, and the MSC 222a, 222b, and 222c then establishes calls between the local mobile phone 202 and the remote mobile phones 204˜210 or disconnects calls according to the messages. The voice packets generated by the mobile phones 202˜210 are also exchanged through the MSC 222a, 222b, and 222c.

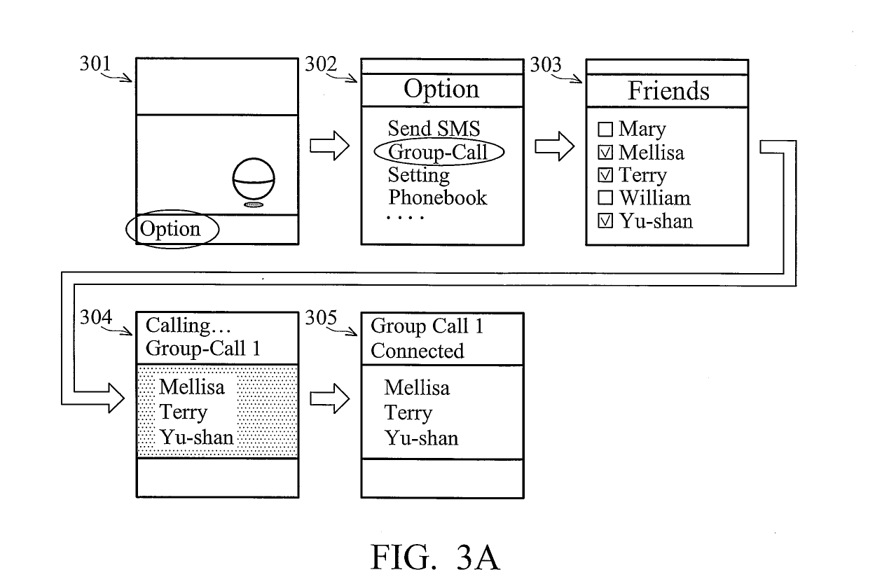

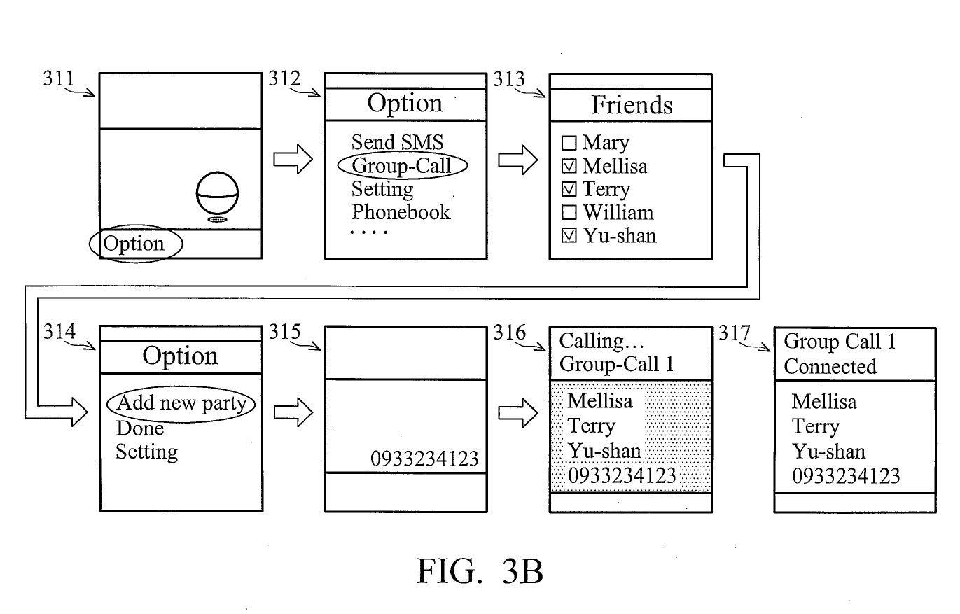

Referring to FIG. 3A, a schematic diagram of an embodiment of MMI manipulations operated by a user to automatically make a conference call according to the invention is shown. Assume that the user wants to make a conference call to communicate with three remote parties including Mellisa, Terry, and Yu-Shan. The user first selects an option item on a screen of a mobile phone at step 301, and then selects a group-call item listed in an option menu at step 302. The mobile phone then displays a phonebook containing multiple items captioned candidate names of remote parties to be selected at step 303. The user then selects the items of Mellisa, Terry, and Yu-Shan. Each item is associated with a phone number of a telephone or a mobile phone corresponding to Mellisa, Terry or Yu-Shan. Thus, a group list referring containing the selected items of Mellisa, Terry, and Yu-Shan are thus generated at step 303. Note that, in step 303, user may directly input a phone number of a telephone or a mobile phone corresponding to Mellisa, Terry or Yu-Shan without the phonebook.

After the group list is generated, the local mobile phone directly performs an automatic conference-call procedure to make an automatic conference call according to the group list at step 304. After the conference call between the local mobile phone corresponding to the user, and remote telephones/mobile phones corresponding to Mellisa, Terry, and Yu-Shan is established, the mobile phone displays information on the screen to notify the user that the conference call has been made at step 305. Compared to the method disclosed in FIG. 1, the user only needs to select the called parties of the conference call at step 303 and the mobile phone then automatically establishes the conference call, saving the user a lot of time and effort in manipulating the mobile phone. Thus, the method disclosed in FIG. 3 is far more convenient for the user than the method disclosed in FIG. 1.

Referring to FIG. 3B, a schematic diagram of another embodiment of MMI manipulations operated by a user to automatically make a conference call according to the invention is shown. The steps 311, 312, and 313 are the same as steps 301, 302, and 303 of the FIG. 3A. The user selects an option for adding new party participating in the conference call in addition to Mellisa, Terry and Yu-Shan at step 314 and directly inputs a phone number “0933234123” of a telephone of the new party without the phonebook at step 315. The conference call is then automatically established between the user. Mellisa, Terry, Yu-Shan, and the new party at steps 316 and 317.

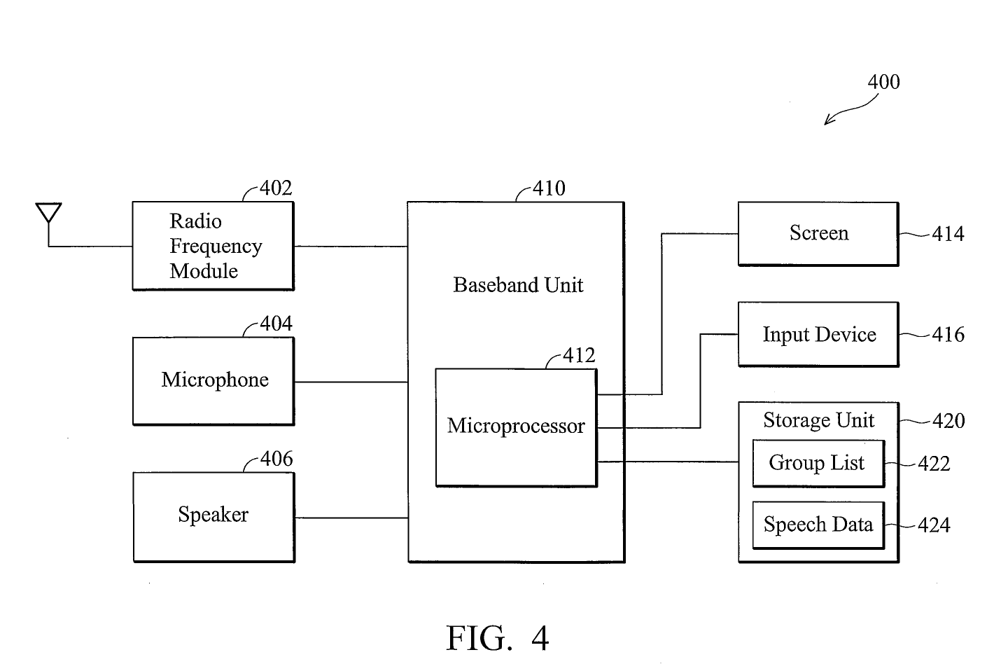

Referring to FIG. 4, a block diagram of an embodiment of a mobile phone 400 for automatically making conference calls according to the invention is shown. The mobile phone 400 comprises a radio frequency (RF) module 402, a microphone 404, a speaker 406, a baseband unit 410, a screen 414, an input device 416, and a storage unit 420. The radio frequency module 402 builds a wireless connection with a base station system (BSS) of a network and communicates with remote parties through the MSC. When the radio frequency module 402 receives radio signals, the baseband unit 410 obtains control messages or voice data from the received radio signals. The received voice data is played via the speaker 406. The microphone 404 converts human speech of the user to voice signals, which is subsequently processed by the baseband unit 410 and sent to the MSC of the network by the radio frequency module 402 and an antenna. The baseband unit 410 comprises a microcontroller 412 coupled to the screen 414, the input device 416, and the storage unit 420. The screen 414 displays menus and messages shown to the user, and the input device 416 receives inputs from the user. The storage unit 420 stores data required by the microcontroller 412.

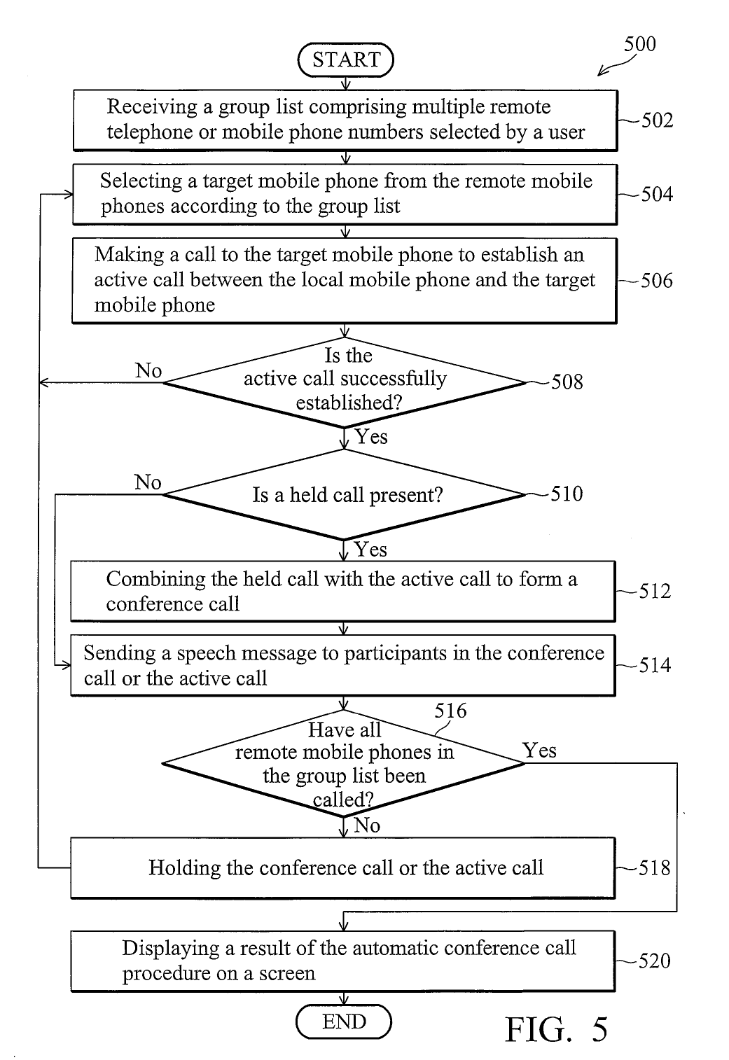

Referring to FIG. 5, a flowchart illustrating an embodiment of a method 500 for automatically making conference calls according to the invention is shown. The mobile phone 400 operates with interaction of MMI manipulations 300 (FIG. 3) by the user to make conference calls. When a user of the mobile phone 400 wants to initiate a conference call, the user provides a list of called parties through steps 301˜304 shown in FIG. 3 to initiate the automatic conference call. The user then inputs a group list comprising multiple remote telephone or mobile phone numbers corresponding to items selected by the user via the input device 416 (step 502). The selection of items is facilitated with operating the input device such as a keypad, a touch panel or others.

Assume that the user A with the local mobile phone 400 selects three items corresponding to remote mobile phones MS_{B}, MS_{C}, and MS_{D} held by remote users B, C, and D as the members of the group list. The baseband unit 410 then performs an automatic conference-call procedure including steps 504˜520 to establish a conference call with remote mobile phones MS_{B}, MS_{C}, and MS_{D} held by users B, C, and D. The baseband unit 410 first selects a target mobile phone from the remote mobile phones according to the group list (step 504). The baseband unit 410 then makes a call to the target mobile phone MS_{B} via the RF module 402 to obtain an active call between the local mobile phone and the target mobile phone (step 506). The call to the target mobile phone, however, may not be successfully established because no respond signal is detected from the target mobile phone, the call request is rejected by a remote user, or others. It is determined whether the active call between the local mobile phone and the target mobile phone is successfully established. If so, the process proceeds to step 510 to perform subsequent operations for the established active call, otherwise, to step 504 to seek another active call. When the call to the target mobile phone is not successfully established, the baseband unit 410 selects another target mobile phone from the remaining remote mobile phones corresponding to items in the group list (step 504), and makes a call to the newly selected target mobile phone to seek another active call (step 506).

When the active call between the local mobile phone and the target mobile phone is successfully established, it is determined whether a held call (i.e. an active call or a multi-party/conference call being on held) is present (step 510). If so, the process proceeds to step S512 for both the held call and the newly established active call, otherwise, to step S514 for the newly established active call. When no held call is present, the baseband unit 410 retrieves speech message 424 from the storage unit 420 and sends the speech message 424 through a network to the target mobile phone associated with the active call via the RF module 402 (step 514). In an embodiment, the speech message informs the remote user with the target mobile phone of current progress for the conference call. For example, the speech message may be read as “This is a conference call from John. John and Mellisa have joined the conference. Terry and Yu-Shan are being invited to join the conference call, please wait”. When a held call is present, the baseband unit 410 then combines the held call with the newly established active call to form a conference call (step 512). After combination of the held call and the newly established active call, the baseband unit 410 sends a speech message to the remote mobile phones associated with the conference call (step 516). For example, the speech message may be read as “This is a conference call from John. Terry, Mellisa and John have joined the conference. Yu-Shan is being invited to join the conference call, please wait”. That is, the speech message informs the remote users about names of the remote users currently participating in the conference call and names of remote users being called to invite them to join the conference call. When the conference call is established, the remote users participating in the conference call can talk to each other while waiting for another remote user to be called.

After sending a speech message to mobile phones participating in the currently established conference call or active call, the baseband unit 410 determines whether all remote mobile phones corresponding to items in the group list have been called (step 516). If so, the process proceeds to step 518 to hold the currently established conference call or active call and then step 504 to seek another active call, otherwise, to step 518 to notify the user that the conference call has been established as shown in step 305 of FIG. 3.

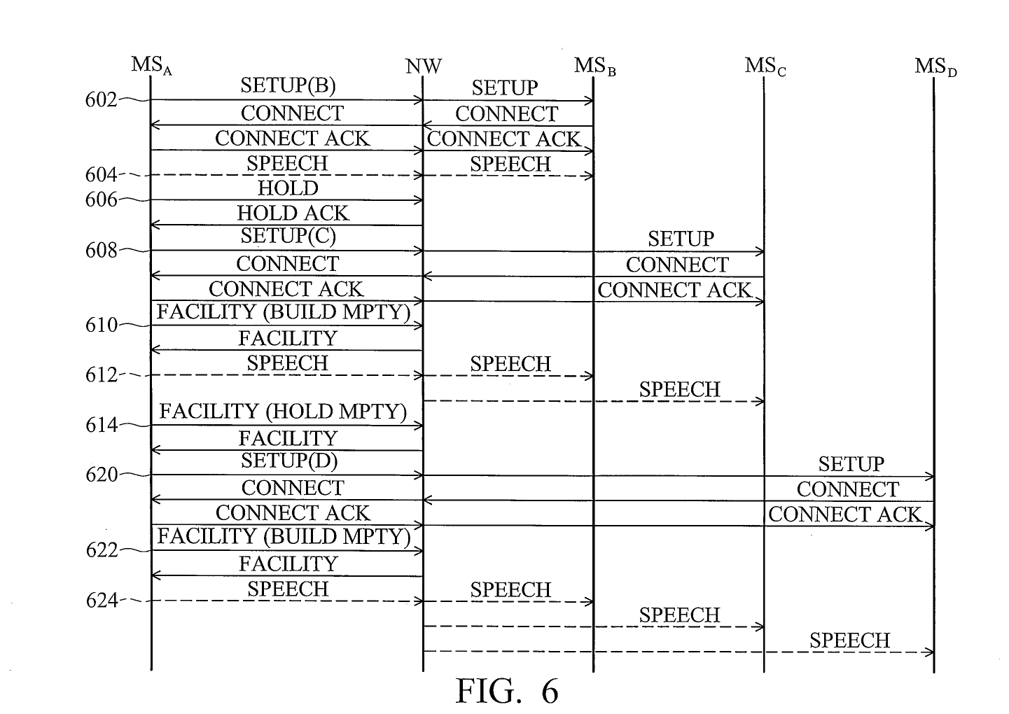

Referring to FIG. 6, a sequence diagram illustrating a first situation of protocol message exchange between the mobile phones MS_{A}, MS_{B}, MS_{C} and MS_{D} to automatically establish a conference call according to the invention is shown. Assume that the local mobile phone MS_{A} wants to make a conference call between the mobile phones MS_{A}, MS_{B}, MS_{C} and MS_{D}. The protocol messages and speech data transmitted between the mobile phones MS_{A}, MS_{B}, MS_{C}, and MS_{D} are all exchanged via a network NW. The local mobile phone MS_{A} first sends a SETUP message 602 with a destination of MS_{B}, indicating a call connection request, to the network NW to seek a call connection to the remote mobile phone MS_{B} (referring to step 506 of FIG. 5). The network NW then forwards the SETUP message to the remote mobile phone MS_{B}. As the remote mobile phone MS_{B} replies with a CONNECT message, indicating acknowledgement of the call connection request, to the local mobile phone MS_{A}, an active call between mobile phones MS_{A} and MS_{B} is established, and the local mobile phone MS_{A} sends a speech message 604 to the mobile phone MS_{B} to inform user B with the mobile phone MS_{B} of current progress for the conference call (referring to step 514 of FIG. 5). The mobile phone MS_{A} then sends a HOLD message 606 to the network NW to hold the active call (referring to step 518 of FIG. 5).

After a held call is obtained, the local mobile phone MS_{A} sends a SETUP message 608 to the remote mobile phone MS_{C} to try to establish an active call with the remote mobile phone MS_{C} (referring to step 506 of FIG. 5). As the remote mobile phone MS_{C} replies with a CONNECT message to the local mobile phone MS_{A}, the active call between mobile phones MS_{A} and MS_{C} is established. The mobile phone MS_{A} then sends a FACILITY(BUILD MPTY) message 610 to the network NW to combine the held call with the active call, and a conference call between the mobile phones MS_{A}, MS_{B}, and MS_{C} is obtained (referring to step 512 of FIG. 5). The local mobile phone MS_{A} then sends a speech message 612 to the remote mobile phone MS_{B} and MS_{C} to inform the users with the mobile phones MS_{B} and MS_{C} of current progress for the conference call (referring to step 512 of FIG. 5). The mobile phone MS_{A} then sends a FACILITY(HOLD MPTY) message 614 to the network NW to hold the conference call (referring to step 514 of FIG. 5).

After a held call is obtained, the local mobile phone MS_{A} sends a SETUP message 620 to the remote mobile phone MS_{D} to try to establish an active call with the remote mobile phone MS_{D} (referring to step 506 of FIG. 5). As the remote mobile phone MS_{D} replies with a CONNECT message to the local mobile phone MS_{A}, the active call between mobile phones MS_{A} and MS_{D} is established. The mobile phone MS_{A} then sends a FACILITY(BUILD MPTY) message 622 to the network NW to combine the held call with the active call, and a conference call between the mobile phones MS_{A}, MS_{B}, MS_{C}, and MS_{D} is obtained (referring to step 512 of FIG. 5). The local mobile phone MS_{A} then sends a speech message 624 to the remote mobile phone MS_{B}, MS_{C}, and MS_{D} to inform the users with the mobile phones MS_{B}, MS_{C}, and MS_{D} that the conference call has been successfully established, and plays speech to inform local user of that the conference call has been successfully established, enabling the users to start to communicate with each other. It is to be understood that establishing the mentioned active and conference calls, and holding active and conference calls may be achieved by the MSC.

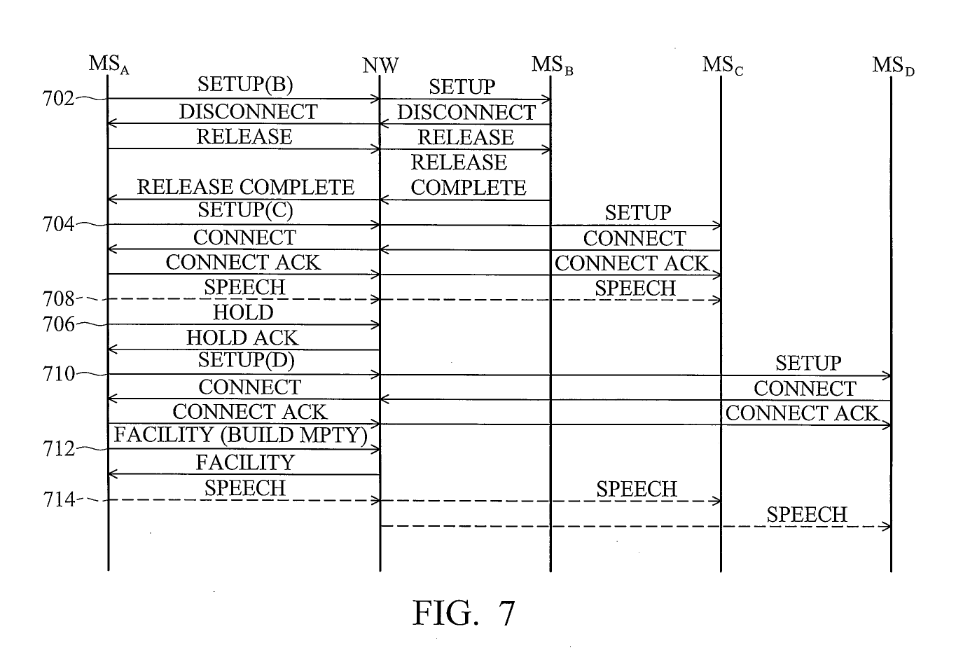

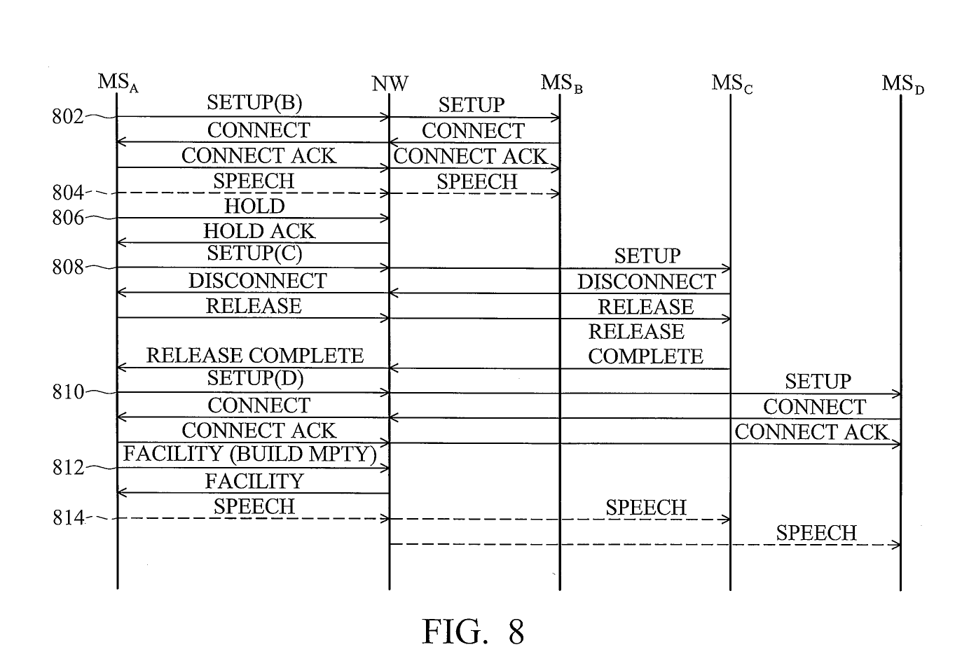

The local mobile station MS_{A} may not always successfully establish a call. When the mobile phone MS_{A} sends a SETUP message to a remote mobile phone, the remote mobile phone may reply a DISCONNECT message, indicating that a call connection request has been rejected or failed, rather than a CONNECT message. Referring to FIG. 7, a sequence diagram illustrating a second situation of protocol message exchange between the mobile phones MS_{A}, MS_{B}, MS_{C} and MS_{D} to automatically establish a conference call according to the invention is shown. The remote mobile phone MS_{B} replies with a DISCONNECT message to the local mobile phone MS_{A} in response to the SETUP message 702, and the local mobile phone MS_{A} selects another remote mobile phone MS_{C} corresponding to a item from a group list (referring to step 504 of FIG. 5) and sends a SETUP message 704 to the mobile phone MS_{C} to make a call to the mobile phone MS_{C} (referring to step 506 of FIG. 5). Referring to FIG. 8, a sequence diagram illustrating a third situation of protocol message exchange between the mobile phones MS_{A}, MS_{B}, MS_{C} and MS_{D} to automatically establish a conference call according to the invention is shown. The remote mobile phone MS_{C} replies with a DISCONNECT message to the local mobile phone MS_{A} in response to the SETUP message 808, and the local mobile phone MS_{A} selects another remote mobile phone MS_{D} corresponding to a item from a group list (referring to step 504 of FIG. 5) and sends a SETUP message 810 to the mobile phone MS_{D} to make a call to the mobile phone MS_{D} (referring to step 506 of FIG. 5). Although mobile phones are introduced as examples, it is not limited thereto. The mentioned embodiments of the systems and methods can also be applied to establish a conference call between a local mobile phone and telephones in the well-known circuit switching network.

The invention provides a method for a mobile phone to automatically make conference calls. A user with the mobile phone only needs to provide the mobile phone with a group list referring to multiple parties participating in the conference. The mobile phone then automatically handles all protocols to establish a conference call according to the group list without intervention of the user. Because the mobile phone can automatically make conference calls without user intervention, user satisfaction is greatly improved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for automatically making conference calls, comprising:
receiving a group list referring to a plurality of remote phones selected or inputted by a user with a local mobile phone; and
performing an automatic conference-call procedure according to the group list with the local mobile phone to establish a conference call between the local mobile phone and the remote phones.

2. The method as claimed in claim 1, wherein performing the automatic conference-call procedure comprises:
selecting a target phone from the remote phones according to the group list;
making a call to the target phone to obtain an active call between the local mobile phone and the target phone;
combining a held call with the active call to obtain a conference call when the active call is successfully established;
holding the conference call or the active call to obtain a held call when at least one of the remote phones have not been called; and
repeating the selecting step to the holding step until all of the remote phones have been called.

3. The method as claimed in claim 2, wherein performing the automatic conference-call procedure further comprises sending a speech message to the remote phones associated with the conference call before the conference call is held, wherein the speech message informs remote users participating in the conference call of current progress for the conference call.

4. The method as claimed in claim 3, wherein the speech message further informs the remote users with remote phones participating in the conference call about user names currently participating in the conference call and user names being called to invite them to join the conference call.

5. The method as claimed in claim 2, wherein performing the automatic conference-call procedure further comprises displaying information on a screen of the local mobile phone to notify the user that the conference call has been made after the conference call is established.

6. The method as claimed in claim 1, wherein receiving the group list comprises:
providing a phonebook containing multiple items captioned candidate names of remote parties to be selected, each item is associated with a phone number of one of the remote phones; and
generating the group list according to the selection of the candidate items by the user.

7. The method as claimed in claim 2, wherein the local mobile phone communicates with the remote phones through a mobile switching center (MSC), and the making step comprises sending a SETUP message asking for establishing the active call to the MSC, and the combining step comprises sending a FACILITY message asking to combine the active call with the held call to form the conference call to the MSC.

8. The method as claimed in claim 2, wherein the local mobile phone communicates with the remote mobile phones through a mobile switching center (MSC), and the holding step comprises:
sending a HOLD message asking for holding the active call to the MSC; and
sending a FACILITY message asking to hold the conference call to the MSC.

9. The method as claimed in claim 2, wherein when the active call between the local mobile phone and the target phone cannot be successfully established, the making step further comprises:
selecting another phone from the remote phones in the group list as another target phone; and
making a call to the newly selected target phone to establish another active call between the local mobile phone with the newly selected target phone.

10. A mobile phone for automatically making conference calls, comprising:
a radio frequency (RF) module;
an input device; and
a baseband unit, coupled to the RF module and the input device, receiving a group list referring to a plurality of remote phones selected or inputted by a user via the input device of the mobile phone, performing an automatic conference-call procedure according to the group list to make a conference call between the mobile phone and the remote phones via the RF module.

11. The mobile phone as claimed in claim 10, wherein the baseband unit selects a target phone from the remote phones according to the group list, makes a call to the target phone via the RF module to establish an active call between the mobile phone and the target phone, combines a held call with the active call to obtain a conference call when the active call is successfully established, holds the conference call or the active call to obtain a held call when at least one of the remote phones have not been called, and repeats the selection to the holding until all of the remote phones have been called.

12. The mobile phone as claimed in claim 11, wherein the baseband unit further sends a speech message to the remote phones associated with the conference call before the conference call is held, and the speech message informs remote users participating in the conference call of current progress for the conference call.

13. The mobile phone as claimed in claim 12, wherein the speech message further informs the remote users with remote phones participating in the conference call about user names currently participating in the conference call and user names being called to invite them to join the conference call.

14. The mobile phone as claimed in claim 11, wherein the mobile phone further comprises a screen, displaying information to notify the user that the conference call has been made after the conference call is established.

15. The mobile phone as claimed in claim 10, wherein the mobile phone further comprises a screen providing a phonebook containing multiple items captioned candidate names of remote parties to be selected, each item is associated with a phone number of one of the remote phones, and the group list is generated according to the selection of the candidate items via the input device by the user.

16. The mobile phone as claimed in claim 11, wherein the mobile phone communicates with the remote phones through a mobile switching center (MSC), the baseband unit sends a SETUP message to the MSC to ask the MSC to establish the active call, and the baseband unit sends a FACILITY message to the MSC to ask the MSC to combine the active call with the held call to form the conference call.

17. The mobile phone as claimed in claim 11, wherein the mobile phone communicates with the remote phones through a mobile switching center (MSC), the baseband unit sends a HOLD message to the MSC to ask the MSC to hold the active call, and the baseband unit sends a FACILITY message to the MSC to ask the MSC to hold the conference call.

18. The mobile phone as claimed in claim 11, wherein when the active call between the local mobile phone and the target mobile phone cannot be successfully established, the baseband unit selects another phone from the remote phones in the group list as another target phone, and makes a call to the newly selected target phone to establish the active call between the local mobile phone and the newly selected target phone.

19. The mobile phone as claimed in claim 11, wherein one of the remote phones is a mobile phone or a telephone in a circuit switching network.
